(19) United States
(12) Patent Application Publication
(10) Pub. No.: US 2006/0217117 A1
(43) Pub. Date: Sep. 28, 2006

(54) Method and device for providing a connecting path to a mobile radio network and telecommunications terminal suitable therefor

(75) Inventor: Manfred Baumkoetter, Oestbevern (DE)

Correspondence Address: KENYON & KENYON LLP, ONE BROADWAY, NEW YORK, NY, 10004, US

(73) Assignee: THALES, Neuilly Sur Seine (FR)

(21) Appl. No.: 10/534,768

(22) PCT Filed: Nov. 10, 2003
(86) PCT No.: PCT/DE03/03729

§ 371 Date: May 9, 2006

(30) Foreign Application Priority Data
Nov. 12, 2002 (DE) 102 53 436.5

(51) Int. Cl. H04Q 7/20

(52) U.S. Cl. 455/432.1; 455/436

(57) ABSTRACT

A method and device for providing a connecting path to a mobile radio network and to a telecommunications terminal suitable therefor is presented. The method and/or device permits a connection setup from or to a telecommunications terminal, which can be used in a mobile radio network, over alternative connecting paths. Either a radio link (radio path) or a link (Internet connecting path), which involves the Internet, are used as a connecting path between said telecommunications terminal and the access and switching units of the mobile radio network in order to set up a telecommunications connection between the telecommunications terminal, which is to be used in the mobile radio network, and a remote station.

### FIELD OF THE INVENTION

The present invention relates to a method and a system for providing a communication path to a mobile telephony network, and also a telecommunications terminal suitable therefor. The telecommunications terminal or communication device may include other functions (i.e., the terminal/device may not be exclusively used for communication purposes).

### BACKGROUND TECHNOLOGY

In available mobile telephony networks, when setting up a telecommunication connection, the terminals used for mobile telecommunication such as cellular phones or comparable devices with possibly expanded functionality are connected to the switching units, the MSC (Mobile Switching Center—Mobile Switching Device), exclusively via radio systems of the corresponding mobile telephony network. The mobile telephony device is connected to the MSC via a radio channel by way of a radio base station (BSS—base station subsystem), the connection being routed as a function of the location of the mobile telecommunication terminal and the radio cell corresponding thereto, via a transmitter/receiver station (BTS—base transceiver station) and the control device (base station control) of the radio base station. However, the number of free radio channels to a BSS, and thus to the individual MSC as well, is limited, so that bottlenecks may result with regard to the availability of telecommunication connections, at least in mobile telephony networks of the current generation. To counter such, the connection charges are relatively high in some instances in an effort to keep the holding times of the channels within limits. In addition, due to areas without reception or due to shielding of the radio waves (in basements of some houses, for instance), the setup of a telecommunication connection via a mobile telephony device is sometimes impossible.

### SUMMARY OF THE INVENTION

The present invention provides a system and method for allowing a communication from or to a telecommunication terminal usable in a mobile telephony network via alternative communication paths. The present invention also provides a telecommunication terminal capable of being used for such communications.

An exemplary embodiment of the method according to the present invention proceeds from the notion of bypassing the conventional communication paths of a mobile telephony network, which run via a radio base station, in the region between a telecommunication terminal suitable for operating in the mobile telephony network and the access and switching units of the mobile telephony network, should such bypassing be necessary for reasons of availability or be desired by the user of the telecommunication terminal for other reasons, and, furthermore, provided it is possible under the preconditions illustrated herein. To set up a telecommunication connection between the telecommunication terminal to be used in the mobile telephony network and a distant terminal, the proposed method may optionally utilize as communication path between this telecommunication terminal and the access and switching units of the mobile telephony network a radio connection (radio propagation path) or a connection that includes the Internet (Internet communication path). This may be done automatically or initiated by a user of the telecommunication terminal. The access and switching units and the telecommunication terminal treat the Internet communication path like another radio cell of the mobile radio communication network. This can applies to the sequences carried out when the telecommunication terminal inscribes or logs in to the mobile telephony communication network after connecting, and to the question of switching the communication path from the radio propagation path to the Internet path or vice versa in the course of a changeover (in an non-existing connection) or in a hand-over (in an existing connection). When detecting a possible Internet path, the user's telecommunication terminal thus initiates the inclusion of the Internet, either automatically or after obtaining the user's consent. If appropriate (or desired), the telecommunication terminal checks in at a virtual radio cell corresponding to the Internet communication path (such as a WLAN access point) in accordance with the rules of the local mobile telephony network (possibly including local authentication, DHCP, etc.). This may be followed by a changeover, handover or, in a new start, for instance, when the telecommunication terminal is turned on, an authentication in the mobile telephony system with a setup of the Internet communication path for access to the mobile telephony network. The implementation of the method is tied to the availability of an already briefly mentioned access point by which the telecommunication terminal suitable for operation in a mobile telephony network, e.g., a cellular phone, is granted access to the Internet. In further embodiments of the present invention, the connection of the telecommunication terminal to the Internet is set up with the aid of an Internet access unit to which the telecommunication terminal is networked in a LAN (Local Area Network) to this end. If a connection is set up that is dispatched from a cellular phone, one of the access and switching units of the mobile telephony network is addressed via the Internet communication path originating from the Internet access unit with the aid of an IP address assigned thereto. In addition, the communication may be set up via an IP-addressable mobile switching unit (MSC Mobile Switching Center or a comparable unit) of the mobile telephony network. If the telecommunication terminal (such as a cellular phone) detects several such access points, they may also be listed in a display of the device, if appropriate. However, an experimental processing of the access points or their processing by a search for particular parameters is conceivable as well.

In further embodiments, the method may allow an Internet communication path existing to an access and switching unit of the mobile telephony network to be rerouted thereby, possibly temporarily, to one that is in a geographically more advantageous location. To this end, the IP address stored in or during the configuration of the system, e.g., in the telecommunication terminal, will be temporarily changed by the access and switching unit in question. In further embodiments, prior to setting up a connection to one of the access and switching units of the mobile telephony network, a query is implemented to a server as a result of which the server transmits to the telecommunication terminal the IP address of an access and switching unit of the mobile telephony network to be addressed, for example. The request at the server may include the transmission of information regarding the current radio area of the telecommunication terminal. In further embodiments, the utilization of an Internet-routed connection to the units (such as the MSC) of the mobile telephony network is billed at a more advantageous rate. This is realized in that the access and connection units of the mobile telephony network addressed via the Internet change the rate structure when setting up a corresponding connection, such change possibly being signaled to the user of the telecommunication terminal.

The inclusion of the telecommunication terminal in the LAN with the Internet access unit may be implemented in the conventional, wire-bound manner or via radio (wireless LAN-WLAN), or also optically, e.g., via an infrared transmission path (IR-LAN).

In a further embodiment, the method as it relates to the telecommunication terminal may be designed to allow incoming and outgoing communications to be set under inclusion of the Internet communication path. For the incoming connections, the information Internet, e.g., the Internet address (IP address) and possibly additional address information of the particular telecommunication terminal, are stored as location information (LA-Location Area) in a location register (VLR-Visited Location Register) of the access and switching units of the mobile telephony network for this purpose. That is to say, it is the information Internet instead of the radio area of its current availability that is stored in the mobile telephony network for the particular subscriber number associated with the telecommunication terminal. The Internet address under which the device may now able to be reached is stored, so that in this case the Internet is basically treated like another radio cell. If the telecommunication terminal (such as the cellular phone) is not directly addressable (IP masquerading), the TCP/UDP port numbers via which the device is connected to the Internet are stored in addition. Here, the system, e.g., the telecommunication terminal or cellular phone, cyclically sends out test data to safeguard the communication (refreshing of the respective entries in the translation table of the router). Changing port numbers are stored accordingly.

If, in an existing connection that includes the Internet, the quality parameters established for this communication are not attained or the connection is interrupted, a further development of the present invention provides that the connection be automatically switched to normal mobile telephony operation. This may be done in that the connection is switched to a radio base station of the mobile telephony network and is routed to the MSC with the aid of a transmit/receive station of the BSS that is assigned to the radio cell corresponding to the location of the telecommunication device, and the associated central control device (BSC) of the BSS. The switching of the communication paths between a pure mobile telephony connection or a connection that includes the Internet is implemented by a switchover of the physical signal path, such switchover being regulated within the framework of a handover/changeover. The telecommunication terminal, e.g., the cellular phone, then reverts to default operation again, i.e., for example, pure radio operation, until a usable Internet connection is detected again. The check of the quality values may be carried out by cyclically exchanged test texts, for instance. A changeover may occur as well, i.e., a passing-on in the case of a non-existing connection, so that the cellular phone may be transferred from a conventional radio cell to the “virtual” radio cell under inclusion of an Internet communication path even in those cases where no connection exists. If the method does not require the consent of the cellular phone user to this end, these procedures (with the exception of rate information, where applicable) take place as in an available mobile telephony operation, in the background and unnoticed by the user.

In embodiments of the present invention, the system for implementing the method includes a telecommunication terminal suitable for operation in a mobile telephony network, an Internet access unit able to be networked therewith in a LAN, as well as an access and switching unit (for instance, MSC) that is addressable via the Internet IP and integrated in the infrastructure of a mobile telephony network.

Further embodiments of the invention provide that the terminal suitable for operation in a mobile telephony network is an appropriately designed TC-system, i.e., for example, a TC system having a mobile telephony unit. The TC system includes a smart card reader for reading smart cards of a mobile telephony provider. According to further embodiments, the TC system is also DSL-enabled, i.e., it utilizes a DSL connection to set up the connection to the access and switching devices of the mobile telephony network via the Internet. In the embodiments, such as the afore-mentioned, the user may be able to dispense with a conventional analog or digital (ISDN) standard telephone line, thus possibly saving the monthly charge for such a fixed subscriber line. Moves or changes in location cause no problems because of the user administration in the access and switching devices of the mobile telephony network.

In further embodiments, the system suitable for implementing the method also includes means by which, if appropriate, it is signaled to a user of the telecommunication terminal in a suitable manner that a less expensive connection than the radio communication path is available by using the Internet connecting path.

In further embodiments, a telecommunication terminal suitable for implementing the method may be designed as mobile telephone (cellular phone), which is equipped not only with the functional units (transmitter and receiver unit, etc.) for the operation in the mobile telephony network, but also with a control unit with a memory and means for integrating the device in a LAN. The control unit may be used to control the switch between the different operating modes that relate to the exclusively mobile-radio supported (mobile telephony operation) or an at least partially Internet-supported (Internet operation) telecommunication. In Internet operation, the control unit controls the LAN-based data exchange with the respective Internet access unit. Various means may alternatively or also simultaneously be provided in the device to integrate the telecommunication terminal into the LAN. In addition to the option of a normal, wire-bound connection to the LAN, for instance, with the aid of suitable plugs, a unit for a radio-based connection to the LAN may be used. The LAN connection between the telecommunication terminal and the Internet access unit may then be configured as so-called wireless LAN (WLAN). In a further embodiment, one may optically couple the telecommunication terminal into the LAN. To this end, an IR transmitter and receiver unit are arranged in the device. Of course, the Internet access unit used for dialing into the Internet must also be provided with a corresponding IR unit for this type of coupling.

In further embodiments of the present invention, the telecommunication terminal allowing utilization of the structures of a mobile telephony network at least under inclusion of the Internet is provided in the form of an appropriately equipped laptop. The laptop has a network card for the wire-bound or wireless connection to a LAN, and a chip card reader for reading chip cards of a mobile telephony provider. For voice communication, i.e., for example, conducting a normal telephone call, the laptop equipped to implement the method may include a soundcard and a headset.

### BRIEF DESCRIPTION OF THE DRAWING

FIG. 1 shows a schematic configuration of the system according to the present invention together with a telecommunication terminal suitable for implementing the method.

### DETAILED DESCRIPTION

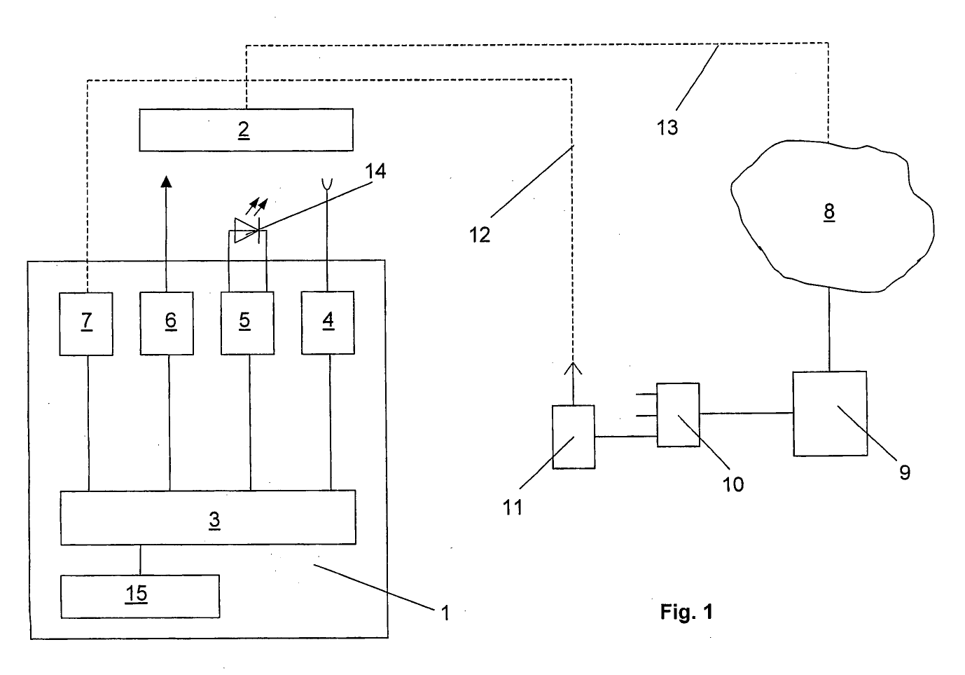

FIG. 1, by way of example, illustrates in a schematic representation both the basic structure of a system for implementing the method and also a telecommunication terminal included in this system. The illustration includes the units for setting up a normal mobile telephony communication, since the option of setting up such a mobile telephony communication is to be preserved according to the present invention and, as already illustrated, the alternative path via the Internet, which technically has equal access in this regard (at a more advantageous rate at most) quasi integrates itself into the structure of the existing mobile radio telephony network.

The system shown in the example essentially includes telecommunication terminal 1 suitable for use in a mobile telephony network, an Internet access unit 2 which is able to be networked with telecommunication terminal 1 in a LAN, and MSC 9 which is IP-addressable via the Internet and integrated in the infrastructure of the mobile telephony network. Internet access unit 2 is a WLAN access point, for instance, which is connected directly to a DSL router via a hub or a switch. If the access point operates openly (without password protection) and uses a DHCP function (a DHCP function can often be activated in a DSL router), various terminals have Internet access via this access point. For the purpose of setting up a radio communication 12, MSC 9 is assigned BTS 11 and BSC 10 of a conventional mobile telephony structure. Telecommunication device 1 shown is a mobile telephone (cellular phone), for instance, whose units 3, 7, 15 such as transmitter/receiver unit 7 provided for its normal use, have been supplemented by additional units 4, 5, 6. The control unit, i.e., controller 3, is a unit that is available in a regular cellular phone, but here is adapted to the expanded functionality of mobile telecommunication terminal 1. Units 4, 5, 6 mentioned last are units that make it possible to network telecommunication terminal 1 with Internet access unit 2 in a LAN in a variety of ways. While unit 4 allows a conventional LAN communication via cable, it is alternatively possible to set up a wireless LAN connection to Internet access unit 2 via units 5 and 6, provided, of course, Internet access unit 2 is equipped accordingly. For instance, using unit 6, a radio-based LAN connection (WLAN) and, via unit 5 having associated optical element 14, an IR-LAN connection to Internet access unit 2 may be set up provided it in turn is equipped with a wireless card or an IR transmitter/receiver unit. Using Internet access unit 2, telecommunication terminal 1 is able to set up an Internet connection 13 and, once the existence of Internet connection 13 has been detected, a connection to IP-addressable MSC 9 via Internet 8. “Bottleneck” radio communication 12 via BTS 11 and BSC 10 to MSC 9 may thus be circumvented. The IP address of MSC 9 must be stored in telecommunication terminal 1 in advance during configuration of the system. It is also conceivable to temporarily modify the IP address afterwards with the aid of the switching system so as to reroute the connection to a switching system that is in a more convenient geographic location or has less traffic. After a connection has been set up and a stable Internet connection 13 is present, the same functions as in standard operation should run when a change occurs in the radio area (LA—Location Area). Technically speaking, Internet communication path 8, 13 is to appear as an additional radio area. In the VLR (Visited Location Register) of MSC 9, the IP address of telecommunication terminal 1 is registered as LA, so that, as far as telecommunication terminal 1 is concerned, outgoing and incoming communications are possible in the same way as in a normal mobile telephony network. However, the system may also include means that are not shown in the figure and which possibly signal to the user that a less expensive connection may be set up if Internet communication path 8, 13 is included. This may be useful if a change in the rate structure is implemented by access and switching units 9, 10, 11, provided they are addressed via Internet 8. For example, the communication path to the mobile telephony network is set up automatically under inclusion of Internet 8, if appropriate. Where applicable, the user of a cellular phone utilized to set up the communication is made aware of this, however, in that the more advantageous rate is signaled, the user thus being able to adapt his talk behavior (call duration) to this type of connection set-up. Instead of a cellular phone, telecommunication terminal 1 may also be a laptop with a network card, a sound card and a headset. However, if the laptop itself does not include a mobile telephony unit, it behaves like a cellular phone from which the call connections are always set up under inclusion of Internet connection 8, 13.

1-18. (canceled)

19. A method for providing a communication path to a mobile telephony network so that a telecommunication connection is set up between a telecommunication terminal designed to be used in a mobile telephony network and a distant terminal, comprising:
utilizing at least one of a radio communication (radio path) and a connection that includes the Internet (Internet connecting path) as a connecting path between the telecommunication terminal and access and switching units of the mobile telephony network, by one of optionally, automatically, and initiated by a user of the telecommunication terminal, the access and switching units and the telecommunication terminal treating the Internet connecting path like another radio cell of the mobile telephony network with respect to sequences that are connected to an activation of the telecommunication terminal and its respective one of check-in and booking into the mobile telephony network and also as they relate to the switchover of the connecting path between radio path and Internet path or vice versa implemented in a changeover or a handover.

20. The method as recited in claim 19, wherein the Internet connecting path is set up via an Internet access unit, which is able to be networked with the telecommunication terminal in a Local Area Network, and one of the access and switching units of the mobile telephony network is addressed by the telecommunication terminal via the Internet access unit and the Internet by means of an internet protocol address, the Local Area Network connection of the telecommunication terminal to the Internet access unit being set up in a conventional fashion, in a wirebound manner, via one of radio, wireless Local Area Network, optics, and infrared transmission.

21. The method as recited in claim 19, wherein the Internet connecting path is routed to a mobile switching unit.

22. The method as recited in claim 20, wherein, if appropriate, an Internet connecting path existing to an access and switching unit of the mobile telephony network is temporarily routed to a geographically more conveniently located access and switching unit, the internet protocol address stored in the telecommunication terminal during configuration of the system being temporarily modified by the particular access and switching unit.

23. The method as recited in claim 20, wherein, prior to a communication set-up to one of the access and switching units of the mobile telephony network, a query is made at a server under transmission of information regarding the actual radio area of the telecommunication terminal, as a result of which the server transmits to the telecommunication terminal the internet protocol address of an access and switching unit of the mobile telephony network to be addressed.

24. The method as recited in claim 20, wherein, if telecommunication connections are set up utilizing the Internet connecting path, the access and switching units of the mobile telephony network change the rate structure for these telecommunication connections.

25. The method as recited in claim 19, wherein, as it regards the telecommunication terminal, the method allows incoming and outgoing communications to be set up utilizing the Internet connecting path, the Internet with the instantaneous Internet protocol address and possibly additional address data regarding the telecommunication terminal being stored as location information for the incoming connections in a location register of the access and switching units of the mobile telephony network.

26. The method as recited in claim 24, wherein the Internet address and the number of the ports used for the communication by means of an Internet protocol are continuously updated by a cyclical data exchange.

27. The method as recited in claim 19, wherein, if in an existing Internet connection quality parameters established for this connection are not attained or an interruption occurs, an automatic switching of the connection to the radio path of the mobile telephony network takes place in that the connection is switched to a radio base station of the mobile telephony network and is routed to the mobile switching unit by means of a transmit/receive station of the radio base station assigned to the radio cell corresponding to the location of the telecommunication device, and by means of the associated central control device, and the location register is updated accordingly.

28. A system for implementing a method for providing a communication path to a mobile telephony network according to which, to set up a telecommunication connection between a telecommunication terminal designed to be used in a mobile telephony network and a distant terminal, a radio communication or a connection that includes the Internet is utilized as connecting path between the telecommunication terminal and the access and switching units of the mobile telephony network, by at least one of optionally, automatically, and initiated by a user of the telecommunication terminal, the access and switching units and the telecommunication terminal treating the Internet connecting path like another radio cell of the mobile telephony network as far as the sequences are concerned that are connected to the activation of the telecommunication terminal and its check-in or booking into the mobile telephony network and also as they relate to the switchover of the connecting path between radio path and Internet path or vice versa implemented in a changeover or a handover, comprising:
a telecommunication terminal provided for use in a mobile telephony network;
an Internet access unit able to be networked with the telecommunication terminal in a Local Area Network; and
an access and switching unit of the mobile telephony network, which is Internet protocol-addressable via the Internet and integrated in the infrastructure of a mobile telephony network in which the mobile telecommunication terminal is able to be used.

29. The system as recited in claim 28, wherein the telecommunication terminal is a transmission control system having a functional unit for mobile telephony communication.

30. The system as recited in claim 29, wherein the transmission control system has a chip-card reader for reading chip cards of a mobile telephony operator.

31. The system as recited in claim 29, wherein the transmission control system is DSL-enabled.

32. The system as recited in claim 28, wherein, if appropriate, includes a device for signaling a user of the telecommunication terminal that a less expensive connection than the radio connecting path is available if the Internet connecting path is utilized.

33. A telecommunication terminal for implementing a method for providing a communication path to a mobile telephony network according to which, to set up a telecommunication connection between a telecommunication terminal designed to be used in a mobile telephony network and a distant terminal, a radio communication (radio path) or a connection that includes the Internet (Internet connecting path) is utilized as connecting path between the telecommunication terminal and the access and switching units of the mobile telephony network, by one of optionally, automatically, and initiated by a user of the telecommunication terminal, the access and switching units and the telecommunication terminal treating the Internet connecting path like another radio cell of the mobile telephony network as far as the sequences are concerned that are connected to the activation of the telecommunication terminal and its check-in or booking into the mobile telephony network and also as they relate to the switchover of the connecting path between radio path and Internet path or vice versa implemented in a changeover or a handover, comprising:
a mobile telephone having functional units for operation in a mobile telephony network and a control unit with a memory and means for integrating the device in a Local Area Network, the control unit controlling the switch between different operating modes with respect to at least one of an exclusively mobile-telephony-based or an at least partially Internet-based telecommunication, wherein in Internet operation, Local Area Network-based data exchange occurs with an Internet access unit.

34. The telecommunication terminal as recited in claim 33, wherein the means for integration in the Local Area Network is a unit for at least one of the wireless-based connection to the Local Area Network and the radio-based connection to the Local Area Network.

35. The telecommunication terminal as recited in claim 33, wherein the means for integration into the Local Area Network is a unit for the optical in-coupling into the Local Area Network.

36. A telecommunication terminal for implementing a method for providing a communication path to a mobile telephony network according to which, to set up a telecommunication connection between a telecommunication terminal designed to be used in a mobile telephony network and a distant terminal, a radio communication or a connection that includes the Internet is utilized as connecting path between the telecommunication terminal and the access and switching units of the mobile telephony network, by one of optionally, automatically, and initiated by a user of the telecommunication terminal, the access and switching units and the telecommunication terminal treating the Internet connecting path like another radio cell of the mobile telephony network as far as the sequences are concerned that are connected to the activation of the telecommunication terminal and its check-in or booking into the mobile telephony network and also as they relate to the switchover of the connecting path between radio path and Internet path or vice versa implemented in a changeover or a handover, comprising:
a laptop having a network card for one of a wire-bound and a wireless connection to a Local Area Network, a soundcard, a headset for voice communication, and a chip-card reader for reading chip cards of a mobile telephony operator, wherein the laptop is designed at least to utilize the mobile telephony network while establishing a connection routed via the Internet.
